(19) United States
(12) Patent Application Publication
(10) Pub. No.: US 2026/0308965 A1
(43) Pub. Date: Oct. 8, 2026

(54) METHOD FOR OPERATING AN ELECTROMOTIVE DOOR ADJUSTER

(71) Applicant: Brose Fahrzeugteile SE & Co. Kommanditgesellschaft, Bamberg, Bamberg (DE)

(72) Inventors: Daniel STEINER, Frankenblick (DE); Maximilian RAU, Coburg (DE); Daniel SCHNAPP, Ebensfeld (DE)

(21) Appl. No.: 19/481,446

(22) PCT Filed: Apr. 29, 2024
(86) PCT No.: PCT/EP2024/061727

§ 371 Date: Nov. 4, 2025

(30) Foreign Application Priority Data
May 4, 2023 (DE) 102023204147.2

(51) Int. Cl. E05F 15/41

(52) U.S. Cl. CPC E05F 15/41; E05Y 2400/3016; E05Y 2400/3017; E05Y 2400/37; E05Y 2400/564; E05Y 2900/531

(57) ABSTRACT

A method for operating an electromotive door adjuster of a motor vehicle, the door adjuster comprising an electric motor and a door driven by the electric motor. During adjustment of the door by means of the electric motor, an acceleration of the door is determined and compared with a limit value. A panic intervention is identified if the acceleration is greater than the limit value. Also disclosed is an electromotive door adjuster.

The invention relates to a method for operating an electromotive door adjuster of a motor vehicle and an electromotive door adjuster.

Motor vehicles, such as passenger cars, usually have a number of doors by means of which an opening in the body of the motor vehicle is covered. Each door is usually movably mounted on the body of the motor vehicle by means of a bearing so that the opening of the body can be released by means of adjusting the door. If the door is a side door, it is therefore possible to enter the interior of the vehicle and/or load the interior with objects.

To increase comfort, the door is usually driven by means of an electric motor of an electromotive door adjuster which also includes the door. When operating the electric motor, the door is moved along an adjustment path that is determined by means of the bearing by means of which the door is mounted on the body. In so doing, it is possible that a user of the electromotive door adjuster cannot fully see an adjustment region of the door formed around the adjustment path and, for example, activates the electromotive door adjuster even though there is an object in the adjustment region. In this case, the adjustment region is the region through which the door moves when it is adjusted along the entire adjustment path and which is defined by means of the outer contour of the door. It is also possible for an object to move into the adjustment region during operation of the electric motor and accordingly during the adjustment of the door. It is therefore possible for a small child to reach into the adjustment region or for an animal to enter it. It is also possible for a user to inadvertently activate the electromotive door adjuster from outside while, for example, a small child is still in the interior the vehicle.

If one of these occurs, the instinctive reaction of the user is to pull on the door and prevent the adjustment thereof or to reverse the adjustment direction so that, for example, the object is safely prevented from getting clamped. Due to the manual operation of the door, comparatively large forces are applied thereto that act on the mechanism between the door and the electric motor, and these are greater than in normal operation. So that the electromotive door adjuster can still operate in the future, it is necessary to adapt the electromotive door adjuster to this comparatively rarely occurring application and consequently to increase its robustness and/or to provide an overload clutch. However, as a result of this, material costs and weight are increased.

The invention is based on the object of presenting a particularly suitable method for operating an electromotive door adjuster of a motor vehicle as well as a particularly suitable electromotive door adjuster of a motor vehicle, wherein manufacturing costs and/or weight are advantageously reduced, and wherein a service life is expediently increased.

With regard to the method, this object is achieved according to the invention by the features of claim 1, and with regard to the electromotive door adjuster, by the features of claim 7. Advantageous further developments and refinements are the subject matter of the respective subclaims.

The method serves to operate an electromotive door adjuster of a motor vehicle. The motor vehicle is in particular land-based and preferably multi-track. In this case, it is suitably possible to position the motor vehicle substantially freely, in particular on a road surface. For this purpose, the motor vehicle is expediently equipped with appropriate wheels. In summary, it is preferably possible to position the motor vehicle substantially independently of other conditions on land. In other words, the motor vehicle is suitably not rail-guided. Preferably, the motor vehicle is a passenger car or a commercial vehicle, such as a truck or bus.

The electromotive door adjuster comprises a door which is driven by an electric motor, preferably along an adjustment path. In the assembled state, the door is suitably movably mounted on a body of the motor vehicle by means of a bearing. For example, the bearing is designed like a hinge, and the door is pivotably mounted relative to the body. Alternatively thereto, a longitudinally displaceable mounting of the door is realized by means of the bearing so that the door is a sliding door. The door is preferably a side door.

Expediently, a further component of the electromotive door adjuster is arranged mechanically between the electric motor and the door, such as a length-adjustable component, in particular a spindle. Alternatively or in combination therewith, a rope drum is arranged therebetween. Preferably, the electric motor first drives a gear, such as a worm gear, by means of which a given spindle is expediently driven. In particular, the electric motor is fixed to the body in the assembled state, which facilitates installation. Alternatively thereto, the electric motor is attached to the door. The electric motor is, for example, a brush-type commutator motor or, particularly preferably, a brushless direct current motor (BLDC). Suitably, the electromotive door adjuster comprises a control device or other control unit by means of which an electric current is provided and/or regulated to power the electric motor so that the electric motor is operated according to a particular specification. The electric motor expediently comprises a sensor for detecting an adjustment position and speed, such as a rotational speed sensor, by means of which a rotational speed of the electric motor can be detected during operation. The sensor preferably comprises a Hall sensor. Due to the mechanical coupling between the electric motor and the door, it is accordingly possible to determine the speed at which the door is moved. This also makes it possible to determine the position of the door. Preferably, the position of the door is also determined during operation by means of the speed sensor.

The door has a door body. In particular, the door body has a partially rigid design and is preferably mounted on the body by means of a given bearing. The electric motor acts in this case primarily on the door body. In particular, the shape of the door body cannot be modified and it comprises, for example, a door module and/or part of an outer skin of the motor vehicle. A window pane of the door is held on the door body and is preferably adjustably mounted there. Suitably, the window pane is a component of an electromotive window lifter which is attached to the door body.

The method involves first adjusting the door by means of the electric motor. In other words, the electric motor is operated in such a way that the door is adjusted. This is preferably done as a function of a signal that is generated, for example, by a user of the motor vehicle, who is also referred to as the user. In particular, an input device is activated to generate the signal. The input device is, for example, a component of the electromotive door adjuster and in particular a door handle which is expediently arranged on a given door body. Alternatively, the signal is generated when a gesture performed by the user is identified using a suitable sensor, preferably contactlessly. In this case, the sensor is, for example, a component of the electromotive door adjuster or is at a distance therefrom. In particular, there is a signal link between the electromotive door adjuster and the sensor or input device, provided that this is not a component of the electromotive door adjuster. The signal link preferably comprises a bus system. Alternatively or in addition thereto, the signal for adjusting the door is specified by means of an on-board computer of the motor vehicle, which is expediently signal-linked to the electromotive door adjuster by means of a given bus system.

Particularly preferably, the door is adjusted automatically by means of the electric motor. In other words, it is not necessary for additional force to be applied to the door by a user for adjusting. In summary, the force applied to the door by the electric motor is sufficient for it to be adjusted thereby. In particular, this is therefore a so-called automatic run.

During adjustment of the door, the acceleration of the door is determined and compared with a limit value. The limit value in this case is, for example, constant or dependent on the current position of the door. In particular, the comparison only takes place when the door is in a certain position or a certain region. Preferably, however, the acceleration of the door along the entire adjustment path is determined and compared with the limit value.

If the acceleration is greater than the limit value, a panic intervention is identified. The panic intervention occurs in particular when the user operates the door manually, as if an additional force that is not applied by means of the electric motor is acting on the door. The panic intervention is carried out, for example, by the user if the adjustment of the door is to be terminated comparatively suddenly, for example because an object is located in the adjustment region, or because adjusting the door was not intended and in particular could lead to a dangerous situation. Preferably, the absolute value of the acceleration is used as the acceleration for comparison. In other words, the panic intervention is only identified if the absolute value of the acceleration is greater than the limit value.

The limit value is suitably selected in such a way that it is not exceeded when the door is adjusted by means of the electric motor. The limit value is expediently selected in such a way that it is not reached during (current) normal operation of the electric motor. In particular, the limit value depends on the current power to the electric motor, preferably a current PWM frequency and/or a duty cycle. Consequently, the current control of the electric motor is used to establish the limit value and/or to verify that the panic intervention has occurred. Alternatively or in combination therewith, a current speed of the door or rotational speed of the electric motor is used for determination/verification.

If the acceleration is less than the limit value, there is, for example, only sluggishness or the like. In this case, the electric motor in particular continues to operate and is preferably regulated to a certain rotational speed so that the door can be adjusted uniformly.

In summary, with the method, panic intervention is reliably detected based on the acceleration of the door, which is functionally related to the forces acting on the door. Since the panic intervention is identified, it is possible to react thereto so that the load is reduced on the electromotive door adjuster, for example the electric motor and/or a mechanism located between the electric motor and the door. Therefore, it is unnecessary to design the electromotive door adjuster to be comparatively robust, which is why manufacturing costs and weight are reduced, and the service life of the electromotive door adjuster is increased.

For example, the message is issued when the panic intervention has been identified. For this purpose, a warning tone or the like is suitably emitted, which signals to the user and/or any object located in the adjustment path that the panic intervention has been identified. This also alerts any object of the adjustment of the door, so that it can, for example, move itself out of the adjustment path/range.

The power to the electric motor is particularly preferably adjusted when the panic intervention has been identified. In so doing, in particular the force that is exerted on the door by means of the electric motor is reduced so that the overall acting forces are reduced. As a result, stress on any mechanics or other components of the electromotive door adjuster is reduced. In other words, due to the adjustment of the power, the forces acting on the door and/or the mechanics between the electric motor and the door are reduced so that damage to the latter is avoided.

In this case, the force applied by means of the electric motor is reduced to such an extent that the door can no longer be adjusted independently. It is therefore expedient to put the electromotive door adjuster into a mode in which manual adjustment of the door is supported, in particular a so-called servo mode. In this case, the force applied to the door by means of the electric motor is insufficient to move the door itself. In this case, in particular, the electric motor is initially powered in the direction of rotation in which it was powered until the door was adjusted. This means that an adjustment of the door in the original direction of movement is still possible.

Particularly preferably, however, the electric motor is still powered in such a way that a force is applied to the door that acts in the direction of acceleration. Consequently, when the panic intervention is identified, the electric motor is powered in such a way that the force is applied to the door that is in the direction of acceleration. Appropriately, to do this, the direction in which the force acts is first determined. For example, the given speed sensor, which in particular comprises the Hall sensor, is used for this purpose. In so doing, the force acting during the panic intervention leads to the acceleration of the door, which, due to the mechanical coupling, leads to a forced rotation of the electric motor. It is therefore possible to use the speed sensor to determine the direction in which the force acts. Because the powering of the electric motor is adjusted in such a way that it applies the force that acts in the direction of acceleration, the forces acting between the door and the electric motor are reduced which prevents damage. This therefore also increases the panic intervention of the user so that the door is moved to the position desired by the user. This means that the user can feel that the panic intervention has been identified, and he is helped to move the door into the desired position so that he is given greater comfort and safety. For example, the direction of rotation of the electric motor is the same as the direction of rotation that the electric motor used to adjust the door. Alternatively thereto, the direction of rotation is opposite to the original direction of rotation.

In an alternative embodiment, for example, the powering of the electric motor is stopped when the panic intervention is identified. In this case, the electric motor is expediently made to freewheel and, in particular, no electrical potential is applied to the given poles of the electric motor so that the electric motor can rotate relatively freely. This makes it easier for the user to move the door into the desired position without having to compensate for the force applied by the electric motor. Particularly preferably in this case, after the panic intervention has been identified, the electric motor is first powered in such a way that the force acting in the direction of acceleration is applied to the door so that initially, a comparatively high acceleration of the door occurs and, for example, a moment of inertia is safely absorbed, in particular if the direction of rotation of the electric motor is changed for this purpose. Following this, the powering of the electric motor is expediently stopped so that the door can be moved into the position desired by the user. Accordingly, comfort is further increased.

To determine the acceleration of the door, a rotational speed of the electric motor is preferably determined, and the acceleration is appropriately derived therefrom. The electric motor and the door are connected to each other via any mechanism, preferably rigidly. Accordingly, there is a functional relationship between the acceleration of the door and the acceleration of the electric motor. Consequently, an already existing rotational speed sensor can be used to determine the acceleration of the door, which is used, for example, to control the adjustment speed of the door. Therefore, manufacturing costs are further reduced. In particular, in this regard, there is a direct comparison of the acceleration of the electric motor with the limit value. In other words, the acceleration of the electric motor is used as the acceleration of the door.

Alternatively thereto, the door, for example, comprises an acceleration sensor which is, for example, attached to the given door body. Accordingly, in particular if the mechanism between the door and the electric motor has play and/or elasticity, the acceleration is identified relatively early, in particular before a force is applied to the electric motor or it is accelerated accordingly. This makes it possible to adjust the power to the electric motor early on. If the force acting on the door is opposite the original direction of movement, the power to the electric motor can already be changed before its direction of rotation is reversed due to the mechanical coupling. This further reduces the load on the electric motor.

The electromotive door adjuster is, in the assembled state, a component of a motor vehicle and is suitable, in particular is provided and equipped, for this purpose. The motor vehicle is, for example, land based and can be a commercial vehicle (truck), bus or, preferably, a passenger car (car). The electromotive door adjuster comprises an electric motor and a door driven thereby. In particular, in this regard, the door is driven along an adjustment path which is determined by a bearing by means of which the door is mounted. The electromotive door adjuster is operated according to a method in which an acceleration of the door is determined during an adjustment of the door by means of the electric motor and compared with a limit value. A panic intervention is identified if the acceleration is greater than the limit value. For example, the acceleration is detected when the door is moved in any direction. Alternatively thereto, this only occurs during the adjustment of the door in a certain direction, for example when performing a closing movement.

The electromotive door adjuster has in particular a control unit which is provided and configured to carry out the method. The control unit comprises, for example, an application-specific integrated circuit (ASIC) or, particularly preferably, a computer which is suitably designed to be programmable. In particular, the control unit comprises a storage medium on which is saved a computer program product, that is also referred to as a computer program, wherein upon execution of this computer program product, i.e. the program, the computer is made to carry out the method. Expediently, the electromotive door adjuster or at least the motor vehicle has a plurality of control elements by means of which an adjustment request can be created. The adjustment request in this context is in particular a signal depending on which the door is adjusted. The control elements are expediently signal-linked to the control unit, in particular via a bus system. The door is, for example, a side door which, in the assembled state, is pivotably mounted on a body of the motor vehicle. The invention further relates to a motor vehicle with such an electromotive door adjuster.

The invention further relates to a computer program product. This comprises a number of instructions which, when the program (computer program product) is executed by a computer, cause it to carry out a method for operating an electromotive door adjuster of a motor vehicle, which comprises an electric motor and a door driven thereby. In the method, during an adjustment of the door using the electric motor, the acceleration of the door is determined and compared with a limit value. A panic intervention is identified if the acceleration is greater than the limit value. The computer is expediently a component of a control unit or electronics and is formed, for example, by means of these. The computer preferably comprises or is formed by means of it. The computer program product is, for example, a file or a data carrier that contains an executable program which, when installed on a computer, automatically carries out the method.

The invention further relates to a storage medium on which the computer program product is saved. Such a storage medium is, for example, a CD-ROM, a DVD or a Blu-Ray disc. Alternatively thereto, the storage medium is a USB stick or other storage device that is, for example, rewritable or can only be writ-ten on once. Such a memory is, for example, a flash memory, a RAM or a ROM.

The invention further relates to a control device which is provided and configured to carry out a method for operating an electromotive door adjuster of a motor vehicle, which comprises an electric motor and a door driven thereby. In the method, the acceleration of the door is determined during an adjustment of the door using the electric motor and compared with a limit value. A panic intervention is identified if the acceleration is greater than the limit value. The control unit comprises, for example, an application-specific integrated circuit (ASIC) and/or a microprocessor by means of which the method is at least partially carried out. In particular, the control device comprises a computer program product which is saved in a memory and which, when the program is executed by a computer, such as the microprocessor, causes it to carry out the method. Preferably, the control unit in the assembled state is a component of the electromotive door adjuster and is suitable, in particular provided and configured, for this purpose. For example, the control unit is a door control unit. For example, a given electric window lifter that is integrated into the door is also controlled by means of the control unit. In this case, the electromotive window lifter preferably comprises a further electric motor by means of which the window pane is driven.

The further developments and advantages explained in connection with the method are also to be transferred analogously to the electromotive door adjuster/the motor vehicle/the computer program product/the storage medium/the control unit as well as to each other and vice versa.

An exemplary embodiment of the invention is explained in more detail below with reference to a drawing. In the figures:

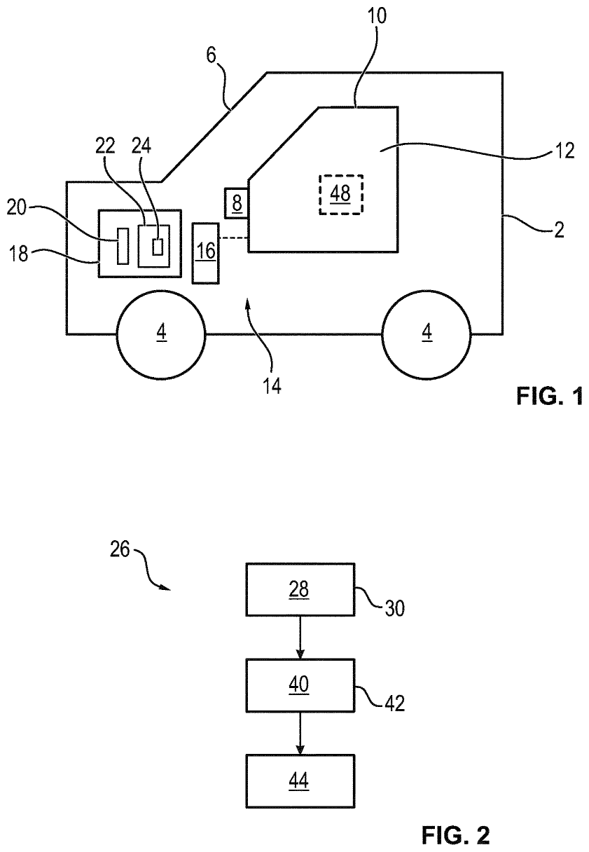

FIG. 1 schematically shows, in a side view, a motor vehicle with an electromotive door adjuster which has an electric motor and a door,

FIG. 2 shows a method for operating the electromotive door adjuster,

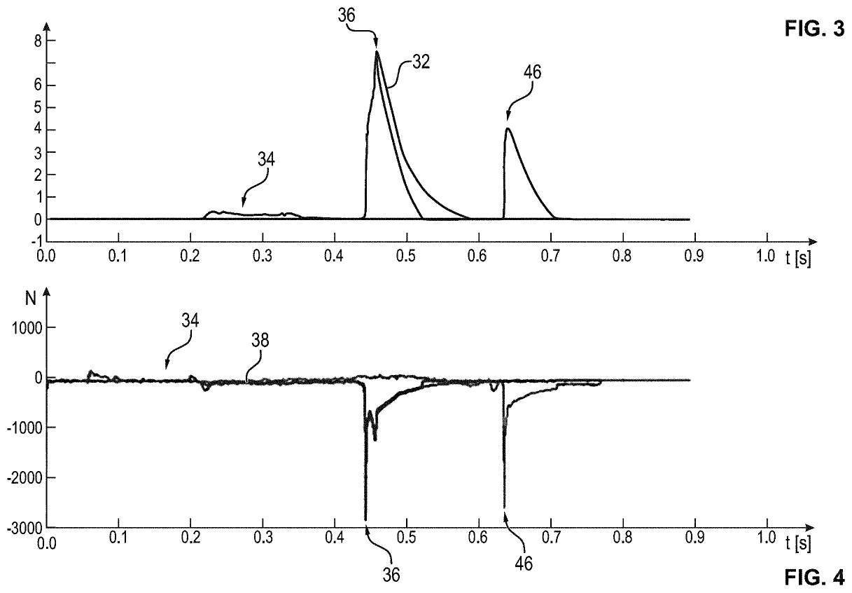

FIG. 3 shows the time curve of a rotational speed of an electric motor during an adjustment of the door,

FIG. 4 shows the time curve of a force acting on the door during the adjustment of the door, and

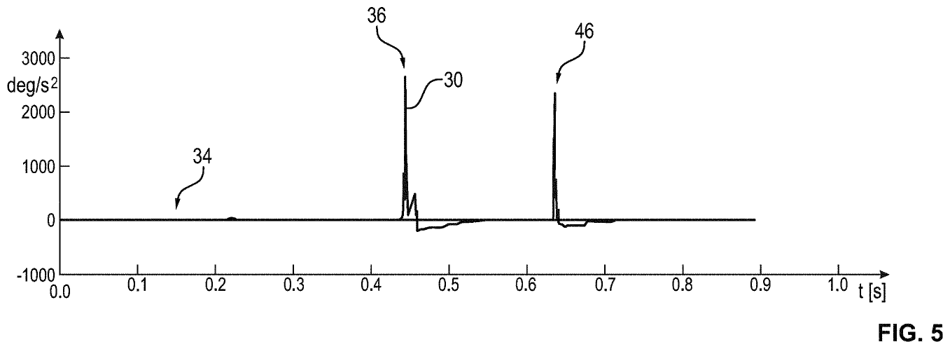

FIG. 5 shows the time curve of an acceleration of the electric motor during the adjustment of the door.

### Corresponding parts are provided with the same reference numbers in all figures.

FIG. 1 shows a simplified schematic representation of a motor vehicle 2 in the form of a passenger car. The motor vehicle 2 has a plurality of wheels 4 by means of which contact is made with a road surface (not shown in detail). The wheels 4 are connected by means of a chassis to a body 6 of the motor vehicle 2, on which a door 10 is also pivotally mounted by means of a hinge 8. For this purpose, a door body 12 of the door 10 is attached to the hinge 8.

The door 10 is a component of an electromotive door adjuster 14 which also has an electric motor 16. The electric motor 16 is designed as a brushless direct current motor (BLDC) and is attached to the body 6. By means of the electric motor 16, a spindle (not shown in detail) is driven via a worm gear and is supported on the door body 12. Accordingly, when the electric motor 16 is powered, the door 10 is adjusted, and the door 10 is driven by means of the electric motor 16.

The electromotive door adjuster further comprises a control unit 18 which comprises a computer 20 in the form of a programmable microprocessor. The control unit 18 also comprises a storage medium in the form of a memory 22 on which a computer program product 24 is saved. In this context, the computer program 24 comprises a number of commands which, when the computer program is executed by the computer 20, cause it to carry out a method 26 shown in FIG. 2 for operating the electromotive door adjuster 14. In other words, the electromotive door adjuster 14 is operated according to the method 26, and the control unit 18 is provided and configured to carry out the method 26.

The method 26 is carried out in this regard when the door 10 is adjusted by means of the electric motor 16. The adjustment of the door is started in particular when a control element, i.e. an input device, of the motor vehicle 2 has been actuated by the user, wherein in particular, a corresponding adjustment request, i.e. a signal for adjusting the door 10, has been created. This is done, for example, by means of manually actuating a door handle of the door 10 (not shown in detail), which is attached to the outside of the door body 12. Alternatively, a corresponding control element is arranged in an interior of the motor vehicle 2, and/or the adjustment request is generated by means of an on-board computer (not shown) of the motor vehicle 2, which is connected to the control unit 18 by means of a bus system. In the method 26, in one variant, the electric motor for adjusting the door 10 is powered in accordance with the adjustment request, or this is done in another method that runs at the same time.

In a first work step 28 of the method 26, an acceleration 30 of the door 10 is determined. In one embodiment, a rotational speed 32 of the electric motor 10 is used for this purpose, whose time curve during the adjustment is shown in FIG. 3. During normal operation 34, the rotational speed 32 is comparatively low and is regulated to a predetermined value to adjust the door 10.

At one point in time, a panic intervention 36 is carried out by a user (not shown in detail), in which the user additionally pulls the door 10 manually. In the shown example, the adjustment of the door 10 is to take place at an increased speed. The reason for this is, for example, that the user wants to get into the interior of the motor vehicle 2 relatively quickly, for example because a small child inside is experiencing an emergency. Due to the manual action on the door 10 and the mechanical coupling of the electric motor 16 to the door 10, the rotational speed 32 increases comparatively strongly. Due to the manual action, the force 38, whose time curve is shown in FIG. 4, acting between the door 10 and the electric motor 16 has a peak. Consequently, the time curve of the acceleration 30, which is shown in FIG. 5, also has a peak during the occurrence of the panic intervention 36, whereas in normal operation 34, the acceleration is substantially zero after the start of the adjustment of the door 10 so that the door 10 is moved at a substantially uniform speed.

In summary, in normal operation 34, the door 10 is substantially adjusted at a constant speed, which is why the force 38 acting between the electric motor 16 and the door 10 is comparatively low. In contrast, during the abrupt acceleration 30 of the door 10 during the panic intervention 36, a comparatively large force 36 acts between the electric motor 16 and the door 10 due to the inertia of the electric motor 16. As a result, the rotational speed 32 of the electric motor 16 subsequently changes comparatively strongly.

Accordingly, the rotational speed 32 corresponds to the acceleration 30 of the door 10, and this is determined based on the rotational speed 32 of the electric motor 16. A time derivative of the rotational speed 32 of the electric motor 16 is used as the acceleration 30 of the door 10. In a variant (not shown in detail), this is additionally multiplied by a factor which is determined based on the mechanical coupling of the electric motor 16 to the door 10.

In a subsequent second work step 40, the acceleration 30 is compared with a limit value 42. In so doing, the acceleration 30 is compared without a sign with the limit value 42, i.e. the magnitude of the acceleration 30. If the acceleration 30 is greater than the limit value 42, the panic intervention 36 is identified in this case. The limit value 42 in this case is selected in such a way that it is not reached in normal operation 34 because, for example, the electric motor 16 has too little power. In this case, the limit value 42 is in particular constant. Alternatively thereto, the limit value 42 is variable and is selected in particular based on the speed of the door 10, i.e. the rotational speed 32 of the electric motor 16. In this case, the limit value 48 is preferably adapted depending on the powering of the electric motor 16, preferably depending on a duty cycle with which the electric motor 16 is operated, that is to say in particular depending on a force applied by means of the electric motor 6. In this case, the limit value 42 corresponds in particular to twice or 1.5 times the force applied by means of the electric motor 16. Accordingly, the limit value 42 is only exceeded if an additional force acts, namely the force applied by the user to the door 10 during the panic intervention 36.

If the panic intervention 36 is present, a third work step 44 is carried out. In this, the power to the electric motor 16 is adjusted. In so doing, the electric motor 16 is initially powered in such a way that a force is applied to the door 10 which acts in the direction of the acceleration 30. Consequently, the user is helped with his manual operation of the door 10 so that on the one hand, the door 10 is opened comparatively quickly. On the other hand, in this way the force 38 acting between the door 10 and the electric motor 10 due to the manual actuation of the door 10 is reduced, which avoids damage to the electromotive door adjuster 14. To determine the direction in which the acceleration 30 is directed, the rotational speed 32 of the electric motor 16 is evaluated. The change in the direction of movement is determined in this case based on the rotational speed 32 of the electric motor 16.

If the user 10 changes the adjustment movement of the door 10 by means of the panic intervention 36, for example, during a closing process, the door 10 is opened by means of the panic intervention 16, the direction of power of the electric motor 16 is also changed so that it now drives the door 10 to move open. In this case too, the force 38 acting between the door 10 and the electric motor 16 is reduced, and damage to the electromotive door adjuster 14 is avoided. After the initial application of force to the door 10 after detection of the panic intervention 36, the powering of the electric motor 16 is terminated so that the user can now move the door 10 to a desired position without having to compensate for forces applied by the electric motor 16 to do this. In other words, the power to the electric motor 16 is stopped.

In the variant shown here, however, the electric motor 16 is operated in the direction in which the user has applied the force to the door 10 until an end position of the adjustment path is reached. Accordingly, the electromotive door adjuster 14 switches back to normal operation 34 so that the first and second work steps 28, 40 are carried out again. In the shown example, a further panic intervention 46 takes place so that the power to the electric motor 16 is adjusted again.

In an alternative embodiment of the electromotive door adjuster 14, the door 10 has an acceleration sensor 48 which is attached to the door body 12. By means of this, the acceleration 30 of the door 10 is measured directly, and the limit value 42 is adjusted accordingly. In this variant, it is possible to adjust the power to the electric motor 16 early on so that the force 38 acting between the door 10 and the electric motor 16 is further reduced.

In both variants, due to the reduction of the force 38 acting between the electric motor 16 and the door 10, excessive stress on the electromotive door adjuster 14, in particular on the mechanism, is reduced and peak forces are absorbed. Accordingly, it is not necessary to design the electromotive door adjuster 14 to be comparatively robust, which is why manufacturing costs are reduced. It is also not necessary, for example, to provide an overload clutch between the electric motor 16 and the door 10, which is why the manufacturing costs of the electromotive door adjuster 14 are further reduced.

Furthermore, the mounting point of the electromotive door adjuster 14 on the body 6 is stressed less so that robustness can also be reduced there. This makes it possible to use comparatively thin sheet metal to create the body 6 in this region, which leads to a reduction in weight and material costs. It is also possible to use an already existing electromotive door adjuster 14, wherein the control unit 18, in particular the computer program product 24, is adapted so that the method 26 can be carried out.

The invention is not restricted to the exemplary embodiment described above. Rather, other variants of the invention can likewise be derived from this by the person skilled in the art without departing from the subject matter of the invention. In particular, all individual features described in connection with the exemplary embodiment can further also be combined with one another in other ways without departing from the subject matter of the invention.

### List of Reference Numbers

2 motor vehicles
4 wheel
6 body
8 hinge
10 door
12 door body
14 electromotive door adjuster
16 electric motor
18 control unit
20 computer
22 memory
24 computer program
26 method
28 first work step
30 acceleration
32 rotational speed
34 normal operation
36 panic intervention
38 force
40 second work step
42 limit value
44 third work step
46 further panic intervention
48 acceleration sensor

1. A method for operating an electromotive door adjuster of a motor vehicle, which comprises an electric motor and a door driven thereby, in which:
during an adjustment of the door by means of the electric motor, an acceleration of the door is determined and compared with a limit value, and
a panic intervention is identified if the acceleration is greater than the limit value.

2. The method according to claim 1, wherein the power to the electric motor is adjusted when the panic intervention has been identified.

3. The method according to claim 2, wherein the electric motor is powered in such a way that a force is applied to the door which acts in the direction of acceleration.

4. The method according to claim 2, wherein the power to the electric motor (16) is stopped.

5. The method according to of claim 1, wherein the acceleration of the door is determined based on a rotational speed of the electric motor.

6. The method according to claim 1, wherein the acceleration of the door is measured by means of an acceleration sensor of the door.

7. An electromotive door adjuster of a motor vehicle, which comprises an electric motor and a door driven thereby, and which is operated according to a method according to claim 1.

8. The method according to claim 3, wherein the power to the electric motor is stopped.

9. The method according to claim 2, wherein the acceleration of the door is determined based on a rotational speed of the electric motor.

10. The method according to claim 3, wherein the acceleration of the door is determined based on a rotational speed of the electric motor.

11. The method according to claim 4, wherein the acceleration of the door is determined based on a rotational speed of the electric motor.

12. The method according to claim 2, wherein the acceleration of the door is measured by means of an acceleration sensor of the door.

13. The method according to claim 3, wherein the acceleration of the door is measured by means of an acceleration sensor of the door.

14. The method according to claim 4, wherein the acceleration of the door is measured by means of an acceleration sensor of the door.

15. An electromotive door adjuster of a motor vehicle, which comprises an electric motor and a door driven thereby, and which is operated according to a method according to claim 2.

16. An electromotive door adjuster of a motor vehicle, which comprises an electric motor and a door driven thereby, and which is operated according to a method according to claim 3.

17. An electromotive door adjuster of a motor vehicle, which comprises an electric motor and a door driven thereby, and which is operated according to a method according to claim 4.

18. An electromotive door adjuster of a motor vehicle, which comprises an electric motor and a door driven thereby, and which is operated according to a method according to claim 5.

19. An electromotive door adjuster of a motor vehicle, which comprises an electric motor and a door driven thereby, and which is operated according to a method according to claim 6.
